(19) United States
(12) Patent Application Publication
(10) Pub. No.: US 2013/0275954 A1
(43) Pub. Date: Oct. 17, 2013

(54) INTER-PROCEDURAL UNREACHABLE CODE ELIMINATION WITH USE GRAPH

(71) Applicant: Youpu Zhang, Kildeer, IL (US)

(72) Inventor: Youpu Zhang, Kildeer, IL (US)

(73) Assignee: Futurewei Technologies, Inc., Plano, TX (US)

(21) Appl. No.: 13/449,096

(22) Filed: Apr. 17, 2012

(51) Int. Cl. G06F 9/45

(52) U.S. Cl. 717/154

(57) ABSTRACT

Methods, apparatuses, and computer readable media for unreachable code identification and removal. A method includes generating a Use Graph for a program. Generating the Use Graph includes identifying global identifiers within the program, creating a node in the Use Graph for each of the global identifiers, traversing the program to identify each use of a global identifier, and creating edges in the Use Graph corresponding to each identified use of a global identifier. The method includes storing usee global identifiers identified from the Use Graph, and determining unused global identifiers corresponding to identified global identifiers that are not usee global identifiers. The method includes removing unreachable software code associated with the unused global identifiers from the program to produce a revised program and storing the revised program.

### TECHNICAL FIELD

The present disclosure relates generally to compiler system optimizations, and more particularly the optimization of code prior to compilation.

### BACKGROUND

Inter-procedural optimization of software code is increasingly used in compiler systems. While memory and other data storage mediums such as magnetic disks have rapidly increased in size and decreased in cost, there are still advantages to optimizing code in many applications.

Previous optimization methods have included one or more of inline procedures, call graphs, and inter procedural level parallelization. In one example, the project ALTO, a link time optimization for Digital Unix executable code is performed using local factoring, procedural abstraction and other methods to compress the code size. A need exists for an improved inter-procedural optimization method.

### SUMMARY

In accordance with one embodiment, there is provided a method for unreachable code identification and removal. The method includes generating a Use Graph for a program. Generating the Use Graph includes identifying global identifiers within the program, creating a node in the Use Graph for each of the global identifiers, traversing the program to identify each use of a global identifier, and creating edges in the use graph corresponding to each identified use of a global identifier. The method includes storing usee global identifiers identified from the Use Graph, and determining unused global identifiers corresponding to identified global identifiers that are not usee global identifiers. The method includes removing unreachable software code associated with the unused global identifiers from the program to produce a revised program and storing the revised program.

Other embodiments include various hardware apparatuses and computer readable media configured to perform processes as described herein.

Other technical features may be readily apparent to one skilled in the art from the following figures, descriptions, and claims.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of an apparatus configured to perform processes as described herein, in accordance with disclosed embodiments;

FIG. 2 is a block diagram of one embodiment of modules 200 configured to compile and optimize source code, in accordance with disclosed embodiments;

FIG. 3 depicts a flowchart of a process for generating a Use Graph for a program, in accordance with disclosed embodiments; and

FIG. 4 depicts a flowchart of one embodiment of a method for the elimination of unreachable software code in a program by using a generated Use Graph, in accordance with disclosed embodiments.

### DETAILED DESCRIPTION

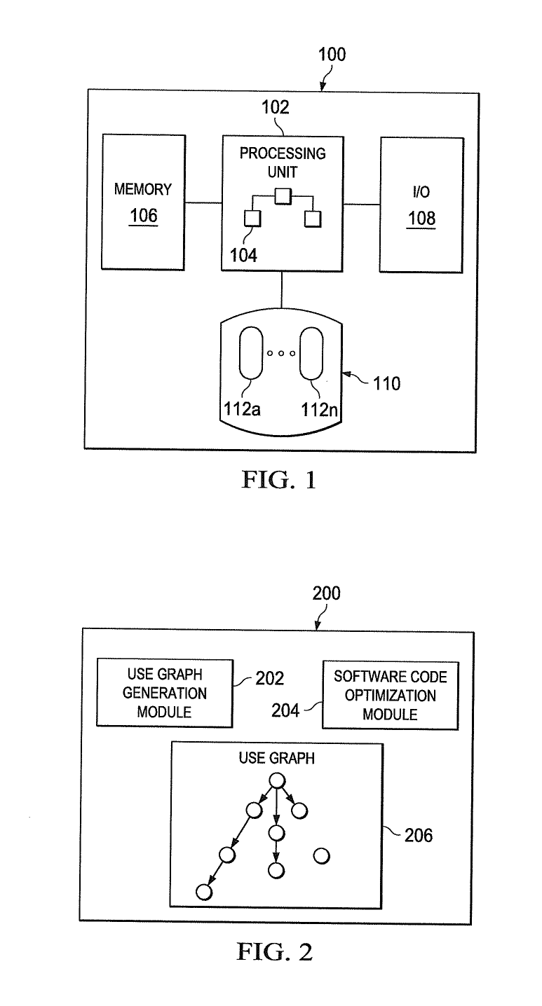

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Some examples of previous optimization methods include inline procedures, inter-procedural level parallelization, and call graphs. One method in particular, call graphs, have been used for similar optimization, but can be distinguished from the techniques disclosed herein. A call graph is a directed graph based on a caller-callee relationship between procedures in a computer program, and tracks specific calls between a caller portion of the program and a “callee” or called portion of the program. In the event of interruption or multi-processing in which a caller may be outside of the user program, a static call graph may not be able to be determined using a call graph.

Disclosed embodiments address such deficiencies and provide a new method for optimization including creating a “Use Graph.” A Use Graph is a directed graph that represents “using” relationships or “a user-usee relationship” between procedures and variables in a computer program. This different type of relationship, user-usee, allows for the determination to be made by the computer as to which procedures or global variables are impossible to be used statically. When the system has identified program code, procedures, or variables that cannot be used, this unreachable code can be removed from the program to ensure more efficient compilation and execution, and to reduce storage and memory requirements.

Various embodiments can divide an entire program, including all functions and global variables, into two parts—“possible to be used” and “impossible to be used.”

Various embodiments can include a number of specific features. For example, the techniques disclosed herein are particularly applicable to programs written in a programming language such as C or a similar language. Such a program can have many files, for example *.c or *.s files, which each can include interacting functions, procedures, and variables. The programs can be composed by flat procedures having at least one start point, such as main in the C language. Various embodiments address programs that have global and local variables. As is known in the art, global variables are exposed to and accessible by all procedures in the program, while local variables are defined inside of a specific procedure and only used by that procedure.

As described herein, the program may be multi-threading and/or multi-processing as well as have procedures which will be called by interruption or another process outside of the program. In other words, while the caller may be outside of the program, the callee must be inside of the program.

Various embodiments include the use of a “global identifier.” As used herein, a “global identifier” refers to a unique identifier assigned to each separate procedure in a program, and to each global variable in the program. The identifier can be the name of the procedure or variable, as long as it is unique in the program, or can be an assigned identifier sufficient to uniquely identify the corresponding procedure or global variable.

To further illustrate the difference between a call graph and a Use Graph, sample Program 1 is illustrated below in Table 1. In Program 1, there are 2 files in the program—“File1.c” and “File 2.c”.

TABLE 1
Program 1

| //File1.c | //File2.c |
|---|---|
| (1) extern void c0( ); extern | (1) #include <stdio.h> |
| void d1( ); | |
| (2) void (*fc[1])( )={c0}; | (2) void c0( ) {printf (“This is c0\n”);} |
| (3) void main ( ){ | (3) void d1( ) {printf(“This is d1\n”);} |
| (4) for (int i=0; i<1; i++) | |
| {fc[i]( );} | |
| (5) d1( ); | |
| (6) } | |

There are four global identifiers in Program 1: main (File1.c:line3), fc (File1.c:line2), c0 (File2.c:line2), and d1 (File2.c:line3). From a “Call Graph” viewpoint, main calls d1 by name and main calls c0 by its address. From a “Use Graph” viewpoint, by contrast, main uses fc and d1, and fc uses c0. The Use Graph for Program 1 may be represented by the following equation: E={main [symbol] fc, main [symbol] d1, fc [symbol] c0}. As shown, while there is a call relationship between procedures from a “Call Graph” view point, there is a user-usee relationship between global identifiers, including both procedures and global variables, from a “Use Graph” view point.

According to various embodiments, there are two kinds of procedure calls in the programming language to be addressed by the processes disclosed herein: “call by name”, where a procedure is called by another process by its name, and “call by address”, where a procedure is called by another process by retrieving and calling the memory address associated with the procedure. Similarly, various embodiments operate on two kinds of global variable uses in the program: “use by name”, where a global variable is referenced by a process by its name, and “use by address”, where a global variable is referenced by another process by retrieving and calling the memory address associated with the global variable.

A “call by address” procedure uses two distinct steps. First, a process must load the address of the procedure and save it to a variable (use step), and second, the process must call the variable which is holding the address of the procedure (call step). After a program loads the address of a procedure and saves it to a variable, it may have a complex process to send the address to other places. In various embodiments disclosed herein, how and where the address is sent is unimportant in implementing the Use Graph. Instead, the only concern is that the address of the procedure or global variable has been used. In other words, if the address of a procedure or global variable is never read, it is impossible to call the procedure or global variable by its address, and the procedure or global variable can be considered unreachable code if it has also not been called by name.

Because a majority of procedures are called by “main” or a program language's version of main, either directly or indirectly, a call graph will work for determining much of the code that can be eliminated. However, sometimes a part of a procedure will work as a “call back function” or “interruption function”, where the process calling the procedure is outside of the program being analyzed. In these cases, information cannot be determined about the caller, and so it is impossible to define the call relation in a call graph.

By contrast, a Use Graph as disclosed herein does not need to know what or where the caller process is, and is only interested in whether a procedure may be used. If an address has been loaded, a Use Graph can understand that the procedure may be used by some process because its address has been loaded, and so can consider it possible to be “used”. In this case, a program may be separated into two parts—“possible to use” and “impossible to be used.”

FIG. 1 is a block diagram depicting components of an apparatus 100 configured to perform processes as described herein, in accordance with disclosed embodiments. Of course, this exemplary apparatus is only one example of an appropriate hardware implementation, and other hardware configured to operate as disclosed herein is also intended to fall within the scope of the claims.

Apparatus 100 may include a processing unit 102 for processing and accessing data, such as source code, and optimizing and compiling the source code. The processing unit 102 may execute software 104 operable to perform compiling and optimizing functionality when configured on the apparatus 100. Software modules that operate in software 104 are described below in more detail in reference to FIG. 2.

Memory 106 may also be located within the apparatus 100 for storing data being processed by the processing unit 102. The apparatus 100 may include an input/output (I/O) unit 108 for receiving and communicating data, such as from a keyboard or to a display or monitor (not shown), or otherwise. Apparatus 100 can include other components as may be desirable for any particular embodiment.

A data storage unit 110 may be included in, or be in communication with, the apparatus 100. The data storage unit 110 may be a hard drive or any other type of volatile or non-volatile memory capable of storing data. Within the data storage unit 110 may be one or more repositories 112a-112n (112), such as a database or multiple databases capable of storing and organizing data. Some example data may include source code, but any information may be stored within the data repositories 112. In one embodiment, rather than including the data storage unit 112, the apparatus 100 may use a memory 106 that is large enough to store any necessary data. Other embodiments of the apparatus 100 may be used without departing from the scope of this disclosure.

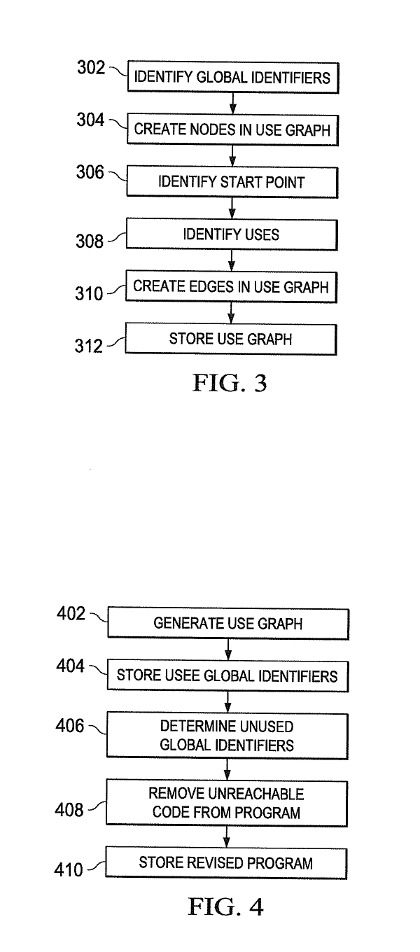

FIG. 2 is a block diagram of one embodiment of modules 200 configured to compile and optimize source code, consistent with the present disclosure, and can be implemented in apparatus 100 and stored in memory 106. A Use Graph generation module 202 may be provided for generating a Use Graph 206. In one embodiment, upon generation of the Use Graph 206, software code optimization module 204 may use the Use Graph 206 to perform optimization of the source code, as described below in greater detail in reference to FIGS. 3 and 4.

FIG. 3 depicts a flowchart of a process for generating a Use Graph for a program, in accordance with disclosed embodiments. A Use Graph for a program, as described herein, is a set of nodes and edges, including a start point node. Such a process can be performed by apparatus 100 or other processing system, referred to generically below as the “system”.

At step 302, the system identifies the global identifiers within a program. Global identifiers include procedures within a program as well as global variables that the program may use. This step can include loading each file in the program, and traversing each line of code in each file of the program to identify each global identifier and storing each of the identified global identifiers. In some cases, this step can include assigning a unique identifier to one or more of the procedures or global variables to ensure that each global identifier is unique.

At step 304, the system creates a node in a Use Graph for each of the global identifiers. This step can include creating a node in the Use Graph for each of the procedures and global variables identified in the program.

At step 306, the system can identify a start point for the program. For a program written in the C language, the start point may ordinarily be the “main” procedure. This step can include creating a node in the Use Graph for the start point.

At step 308, the system can identify each “use” of a global identifier, by use of its associated procedure or global variable. This can include identifying each “use by name” where a procedure or global variable is called in the program by its name or global identifier, and can include identifying each “use by address” by identifying where the memory address associated with a procedure or global variable is retrieve (which means it may be used). Identifying the use of a procedure or global variable can include traversing each line of code in each file of the program to identify such use, and can include traversing other program code to identify processes outside the program itself, including interrupt routines, that may use a procedure or global variable. This step can include identifying the “user” global identifier and the “usee” global identifier.

At step 310, the system creates a “used edge” within the Use Graph corresponding to each of the identified uses of each global identifier. A used edge is a directed edge that points to a global identifier node in the use graph that is identified as a “usee” node in that it is used, and can in particular point from the “user” global identifier node to the “usee” global identifier node. For example, for each global identifier in the set of global identifiers, if the start point uses the global identifier, the start point is said to “use” the global identifier. In that case, if the start point is labeled as node “main” and the first global identifier that is used in main is node fc, then main→fc would be added to the set of edges.

For each global identifier in the set of global identifiers, if the global identifier is used by another global identifier, an edge indicating the use relationship is created. When all of the global identifiers have been traversed, a complete set of edges for the Use Graph should be known. Note that even in cases where the global identifier is used by a process outside of the program being analyzed, this global identifier is “used” by a process within the program in order to broadcast its address to the process outside of the program.

At step 312, the system stores the completed Use Graph for the program.

FIG. 4 depicts a flowchart of one embodiment of a method for the elimination of unreachable software code in a program by using a generated Use Graph.

In step 402, the system generates a Use Graph for the program, for example as described above in FIG. 3.

In step 404, the system stores the global identifiers of the Use Graph that are pointed to by one or more used edges; these are the usee global identifiers. In various embodiments, these global identifiers may be stored as the Use Graph is being generated. In an alternate embodiment, the Use Graph may be traversed subsequent to its creation to store the global identifiers. The start point node can be considered a usee global identifier by default.

In step 406, the system determines global identifier nodes in the Use Graph that are not pointed to by a used edge; these correspond to global identifiers are not included within the stored used global identifiers and so are not used by any process. A comparison may be made between the full list of global identifiers and the stored usee global identifiers.

If a global identifier is determined to be unused, then the program has never used its name or address. The determined unused global identifiers are either unreachable code, if the global identifier represents a procedure, or a global variable that cannot be used, if the global identifier represents a global variable. The code associated with unused procedures or unused variables, and not associated with usee global identifiers, is “unreachable code”.

Note that, in some cases, a global identifier by be pointed to by a used edge, indicating that it is called at some point, but there is no “chain” of nodes and edges back to the start point node. In these cases, the set of nodes that are unconnected to the start point node, even if they point to each other. The global identifiers associated with such nodes can all be designated, in some embodiments, as unused global identifiers.

In step 408, the system can remove software code associated with the unused global identifiers (and not associated with any usee global identifier) from the program.

In step 410, software code that is remaining may be stored as revised program code. The stored software code may then be linked by a compiler and turned into object code that is executable by a processor, as is well known in the art.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method of eliminating unreachable software code by using compiler optimization, the method comprising:
generating, by a processor, a Use Graph for a program, wherein generating the Use Graph comprises:
identifying global identifiers within the program;
creating a node in the Use Graph for each of the global identifiers;
traversing the program to identify each use of a global identifier; and
creating edges in the Use Graph corresponding to each identified use of a global identifier; and
storing, in memory, usee global identifiers identified from the Use Graph;
determining unused global identifiers corresponding to identified global identifiers that are not usee global identifiers;
removing unreachable software code associated with the unused global identifiers from the program to produce a revised program; and
storing the revised program.

2. The method of claim 1, wherein the global identifiers include procedures and global variables.

3. The method of claim 1, wherein creating edges in the use graph includes creating a plurality of directed edges each pointing to a node in the Use Graph that corresponds to a usee global identifier.

4. The method of claim 3, wherein each directed edge points from a user global identifier.

5. The method of claim 1, wherein creating edges in the use graph includes creating a directed edge pointing to a node in the Use Graph that corresponds to a global identifier called by a procedure outside the program.

6. The method of claim 5, wherein the procedure outside of the program is performing multi-processing or interruption.

7. The method of claim 1, wherein the unused global identifiers are represented as nodes in the Use Graph that are not connected to any of the edges.

8. An apparatus comprising:
a processor; and
an accessible memory, the apparatus particularly configured to perform the steps of:
generating, by the processor, a Use Graph for a program, wherein generating the Use Graph comprises:
identifying global identifiers within the program;
creating a node in the Use Graph for each of the global identifiers;
traversing the program to identify each use of a global identifier; and
creating edges in the Use Graph corresponding to each identified use of a global identifier; and
storing, in the memory, usee global identifiers identified from the Use Graph;
determining unused global identifiers corresponding to identified global identifiers that are not usee global identifiers;
removing unreachable software code associated with the unused global identifiers from the program to produce a revised program; and
storing the revised program.

9. The apparatus of claim 8, wherein the global identifiers include procedures and global variables.

10. The apparatus of claim 8, wherein creating edges in the use graph includes creating a plurality of directed edges each pointing to a node in the Use Graph that corresponds to a usee global identifier.

11. The apparatus of claim 10, wherein each directed edge points from a user global identifier.

12. The apparatus of claim 8, wherein creating edges in the use graph includes creating a directed edge pointing to a node in the Use Graph that corresponds to a global identifier called by a procedure outside the program.

13. The apparatus of claim 12, wherein the calling procedure outside of the program is performing multi-processing or interruption.

14. The apparatus of claim 8, wherein the unused global identifiers are represented as nodes in the Use Graph that are not connected to any of the edges.

15. A non-transitory computer readable medium encoded with computer-executable instructions that, when executed, cause a processor to perform the steps of:
generating a Use Graph for a program, wherein generating the Use Graph comprises:
identifying global identifiers within the program;
creating a node in the Use Graph for each of the global identifiers;
traversing the program to identify each use of a global identifier; and
creating edges in the Use Graph corresponding to each identified use of a global identifier; and
storing, in memory, usee global identifiers identified from the Use Graph;
determining unused global identifiers corresponding to identified global identifiers that are not usee global identifiers;
removing unreachable software code associated with the unused global identifiers from the program to produce a revised program; and
storing the revised program.

16. The computer readable medium of claim 15, wherein the global identifiers include procedures and global variables.

17. The computer readable medium of claim 15, wherein creating edges in the use graph includes creating a plurality of directed edges each pointing to a node in the Use Graph that corresponds to a usee global identifier.

18. The computer readable medium of claim 17, wherein each directed edge points from a user global identifier.

19. The computer readable medium of claim 15, wherein creating edges in the use graph includes creating a directed edge pointing to a node in the Use Graph that corresponds to a global identifier called by a procedure outside the program.

20. The computer readable medium of claim 19, wherein the calling procedure outside of the program is performing multi-processing or interruption.
